(19) United States
(12) Patent Application Publication
(10) Pub. No.: US 2020/0191338 A1
(43) Pub. Date: Jun. 18, 2020

(54) COUPLING UNIT AND COUPLING DEVICE

(71) Applicant: Panasonic Intellectual Property Management Co., Ltd., Osaka (JP)

(72) Inventors: Masahiro YAMAZAKI, Osaka (JP); Wataru TAKAHASHI, Fukushima (JP)

(21) Appl. No.: 16/787,756

(22) Filed: Feb. 11, 2020

Related U.S. Application Data
(63) Continuation of application No. PCT/JP2018/034721, filed on Sep. 20, 2018.

(30) Foreign Application Priority Data
Oct. 10, 2017 (JP) 2017-196516

(51) Int. Cl. F21K 9/272; F21S 2/00; F21S 8/06; F21V 31/00; F21V 21/005; F21V 23/00

(52) U.S. Cl. CPC F21K 9/272; F21S 2/005; F21S 8/06; F21Y 2103/10; F21V 21/005; F21V 23/002; F21V 31/005

(57) ABSTRACT

A coupling unit includes first and second coupling devices respectively attached to first and second lighting devices. The first coupling device has a first coupling part that couples with the second coupling device and a first projection. The second coupling device has a second coupling part that couples with the first coupling device and a second projection. The first coupling part has at least one cross section that is L-shaped, and the at least one cross section being parallel to a longitudinal direction of the first lighting device. The first projection is perpendicular to the longitudinal direction of the first lighting device. The second coupling part has at least one cross section that is L-shaped, and the at least one cross section being parallel to a longitudinal direction of the second lighting device. The second projection is perpendicular to the longitudinal direction of the second lighting device.

### BACKGROUND

### 1. Technical Field

The present invention relates to a coupling unit and a coupling device. The coupling unit and the coupling device are for a straight-bulb lighting device.

### 2. Description of the Related Art

A plurality of straight-bulb lighting devices are arranged in a space to apply light to objects in the space.

Patent Literature (PTL) 1 discloses lighting devices that apply light to objects in a space.

Here, PTL 1 is Unexamined Japanese Patent Publication No. 2015-6162.

### SUMMARY

In a space where a plurality of straight-bulb lamps are arranged, the lamps are arranged separately. Therefore, illuminance is not even on a surface to which the lamps apply light. Illuminance between the lamps is especially lower than illuminance at a center of each of the lamps, for example.

The present invention is made in view of the situation. The present invention provides a coupling unit and a coupling device that allow illuminance of light to be more even between lamps.

A coupling unit includes a first coupling device attached to a first lighting device supplied with electricity through a power cable and a second coupling device attached to a second lighting device supplied with electricity through a power cable. The first coupling device has a first coupling part that couples with the second coupling device and a first projection provided on a part different from the first coupling part. The second coupling device has a second coupling part that couples with the first coupling device and a second projection provided on a part different from the second coupling part. The first coupling part has at least one cross section that is L-shaped, and the at least one cross section being parallel to a longitudinal direction of the first lighting device. The first projection is perpendicular to the longitudinal direction of the first lighting device. The second coupling part has at least one cross section that is L-shaped, and the at least one cross section being parallel to a longitudinal direction of the second lighting device. The second projection is perpendicular to the longitudinal direction of the second lighting device.

A coupling device that is attached to a lighting device supplied with electricity through a power cable, and is for coupling with a different coupling device attached to a different lighting device supplied with electricity through a power cable. The coupling device includes a coupling part that couples with the different coupling device and a projection provided on a part different from the coupling part. The coupling part has a coupling depression that corresponds to a protrusion of the different coupling device and a coupling protrusion that corresponds to a depression of the different coupling device. The projection is perpendicular to a longitudinal direction of the lighting device.

The present invention provides a coupling unit and a coupling device. In a space where a plurality of lighting devices are arranged, the coupling unit and the coupling device allow illuminance to increase on part of a surface to which the plurality of lighting devices apply light. The part of the surface is the surface that is under between the lighting devices, and is the surface around the surface that is under between the lighting devices.

### BRIEF DESCRIPTION OF DRAWINGS

FIG. 1 illustrates an example of light-emitting diode (LED) lamps in conventional hydroponic growing.

FIG. 2 illustrates an example of an LED lamp supplied with electricity through bases of the LED lamp.

FIG. 3 illustrates an example of a process of attaching an LED lamp to a socket. The LED lamp includes a sealing ring. The LED lamp is supplied with electricity through bases of the LED lamp.

FIG. 4 illustrates an example of a configuration of an LED lamp in hydroponic growing according to an exemplary embodiment. The LED lamp includes a power cable that perpendicularly sticks out of the LED lamp.

FIG. 5 illustrates an example of a plurality of LED lamps according to the exemplary embodiment coupled together by coupling units. The plurality of LED lamps each include a power cable that perpendicularly sticks out of each of the plurality of LED lamps.

FIG. 6 illustrates an example of a configuration of an LED lamp in hydroponic growing according to the exemplary embodiment. The LED lamp includes a power cable that horizontally sticks out of the LED lamp.

FIG. 7 illustrates an example of a plurality of LED lamps according to the exemplary embodiment coupled together by end caps. The plurality of LED lamps each include a power cable that horizontally sticks out of each of the plurality of LED lamps.

FIG. 8 illustrates examples of first shapes of end caps according to the exemplary embodiment.

FIG. 9 illustrates an example of end caps attached to each other. The end caps have the respective first shapes according to the exemplary embodiment.

FIG. 10 illustrates an example in which an arrangement of LED lamps in hydroponic growing according to the exemplary embodiment is compared with an arrangement of LED lamps in conventional hydroponic growing.

FIG. 11 illustrates examples of distributions of illuminance by which an arrangement of LED lamps in hydroponic growing according to the exemplary embodiment is compared with an arrangement of LED lamps in conventional hydroponic growing.

FIG. 12 includes graphs of illuminance by which an arrangement of LED lamps in hydroponic growing according to the exemplary embodiment is compared with an arrangement of LED lamps in conventional hydroponic growing.

FIG. 13 illustrates examples of second shapes of end caps according to the exemplary embodiment.

FIG. 14 illustrates an example of end caps attached to each other. The end caps have the respective second shapes according to the exemplary embodiment.

FIG. 15 illustrates examples of third shapes of end caps according to the exemplary embodiment.

FIG. 16 illustrates examples of fourth shapes of end caps according to the exemplary embodiment.

FIG. 17 illustrates an example of holders that hold LED lamps according to the exemplary embodiment.

### DETAILED EMBODIMENT

(Details about how One Aspect of Present Invention has been Made)

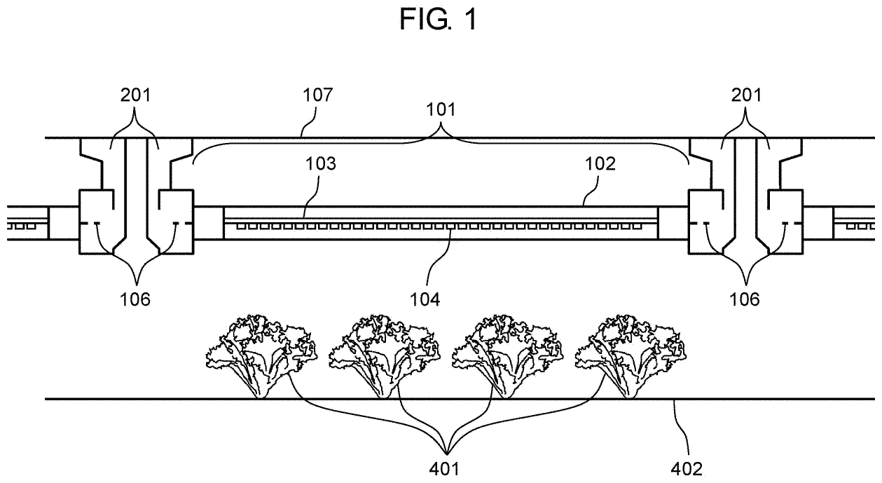

FIG. 1 illustrates an example of light-emitting diode (LED) lamps 101 (an example of lighting devices) in conventional hydroponic growing. The conventional lighting devices are straight-bulb lighting devices. Both lengthwise ends of each of the straight-bulb lamps are fixed by respective sockets 201. Hereinafter, an arrangement of the lighting devices will be described. An arrangement of lamps in hydroponic growing will be exemplified.

As illustrated in FIG. 1, in conventional hydroponic growing, there are LED lamps 101 attached to respective sockets 201, plants 401, and grow bed 402. Each of LED lamps 101 is supplied with electricity through bases of each of LED lamps 101.

Sockets 201 are fixed to ceiling 107. LED lamps 101 are attached to respective sockets 201. Each of LED lamps 101 is supplied with electricity through bases of each of LED lamps 101. Light is applied to plants 401 on grow bed 402 to grow plants 401.

The lighting devices are attached to respective sockets 201. Between sockets 201, LED packages 104 (elements) in one of LED lamps 101 that are adjacent to each other are apart from LED packages 104 (elements) in another LED lamp 101, due to thicknesses of sockets 201 and a space required for attaching LED lamps 101 to sockets 201. Therefore, in a space where the plurality of LED lamps 101 are arranged, illuminance is not even on a surface to which LED lamps 101 apply light.

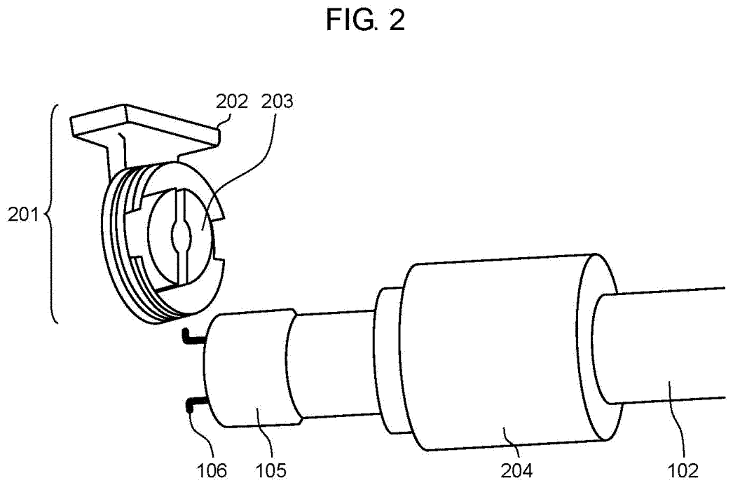

FIG. 2 illustrates a vicinity of base 105 of LED lamp 101 supplied with electricity through bases 105. As illustrated in FIG. 2, LED lamp 101 supplied with electricity through bases 105 is attached to sockets 201. LED lamp 101 includes base pins 106 at both lengthwise ends of LED lamp 101. To attach LED lamp 101 to sockets 201, base pins 106 are inserted into rotatable component 203 of each of sockets 201.

Especially in hydroponic growing, liquid may enter and stay between socket 201 and LED lamp 101, and thus may cause a short circuit or corrosion at terminals. Not to allow liquid to enter and stay between socket 201 and LED lamp 101, LED lamps 101 each include sealing ring 204.

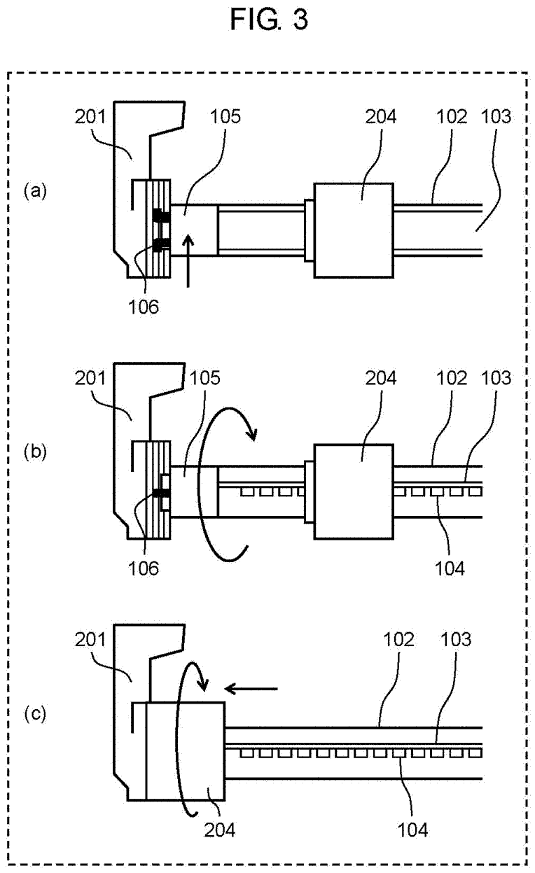

FIG. 3 illustrates an example of a process of attaching LED lamp 101 to socket 201. LED lamp 101 includes sealing ring 204. LED lamp 101 is supplied with electricity through bases of LED lamp 101.

As illustrated in part (a) of FIG. 3, base pins 106 of LED lamp 101 are inserted into rotatable component 203 of socket 201. Then, as illustrated in part (b) of FIG. 3, LED lamp 101 and rotatable component 203 are rotated together 90° to fix LED lamp 101 to socket 201. Consequently, a surface of circuit board 103 on which LED packages 104 are arranged is rotated, and thus the surface faces vertically. Before the rotation, the surface has faced horizontally. Circuit board 103 has a back surface. The back surface of circuit board 103 and the surface of circuit board 103 on which LED packages 104 are arranged make a pair.

Further, as illustrated in part (c) of FIG. 3, sealing ring 204 is fixed to socket body 202 not to allow liquid to stay at LED lamp 101 and socket 201. More specifically, a male thread and a female thread are formed on sealing ring 204 and socket 201, respectively. The male thread and the female thread are used to screw sealing ring 204 to socket body 202. Sealing ring 204 is screwed to socket body 202 by rotating sealing ring 204 relative to socket 201. A seal is disposed in sealing ring 204. The seal does not allow liquid to enter and stick base pins 106 from an outside.

As described above, when a conventional lighting device is attached to a socket, LED lamp 101 is rotated to attach LED lamp 101 to socket 201. Further, sealing ring 204 on the LED lamp 101 is rotated to attach sealing ring 204 to socket 201.

In case of LED lamps 101 illustrated in FIGS. 1 to 3, however, a number of components increases. Further, work required for attaching LED lamps 101 to sockets 201 increases. One of the reasons is that base pins 106 need to be attached to appropriate positions of rotatable component 203 of each of sockets 201. Another reason is that sealing rings 204 need to be preliminarily attached to each of LED pipes 102. Another reason is that sealing rings need to be precisely attached to each of the sockets.

A coupling unit according to an aspect of the present invention includes: a first coupling device attached to a first lighting device supplied with electricity through a power cable of the first lamp; and a second coupling device attached to a second lighting device supplied with electricity through a power cable of the second lamp. The first coupling device has a first coupling part that couples with the second coupling device. The second coupling device has a second coupling part that couples with the first coupling device. The first coupling part has a first protrusion and a first depression. The second coupling part has a second protrusion that corresponds to the first depression, and a second depression that corresponds to the first protrusion.

The configuration allows the coupling unit that includes the first coupling device and the second coupling device to couple a plurality of lighting devices together in such a manner that the plurality of lamps that have been coupled together are adjacent to each other. Therefore, illuminance becomes more even on part of a surface to which the plurality of lamps apply light. The part of the surface is the surface that is under between the lamps coupled together, and is the surface around the surface that is under between the lamps coupled together.

Further, due to the configuration, sealing ring 204 becomes not necessary for each of LED lamps 101 to couple the plurality of lighting devices. Therefore, sealing ring 204 does not need to be attached to each of LED lamps 101. Therefore, a number of components decreases. Further, work required for attaching LED lamps 101 decreases.

Hereinafter, an exemplary embodiment will be described in detail with reference to the drawings as appropriate. In some cases, however, the exemplary embodiment may not be described unnecessarily in detail. For example, well-known matters may not be described in detail. Further, redundant descriptions of substantially same configurations may be omitted. Consequently, the following description is not unnecessarily wordy, and thus is easily understood by a person skilled in the art.

The accompanying drawings and the following description are provided to allow a person skilled in the art to fully understand the present disclosure. It is not intended that the accompanying drawings and the following description limit the subject described in the claims.

### EXEMPLARY EMBODIMENT

[1-1. Configuration of LED Lamp that Includes Power Cable that Perpendicularly Sticks Out of LED Lamp]

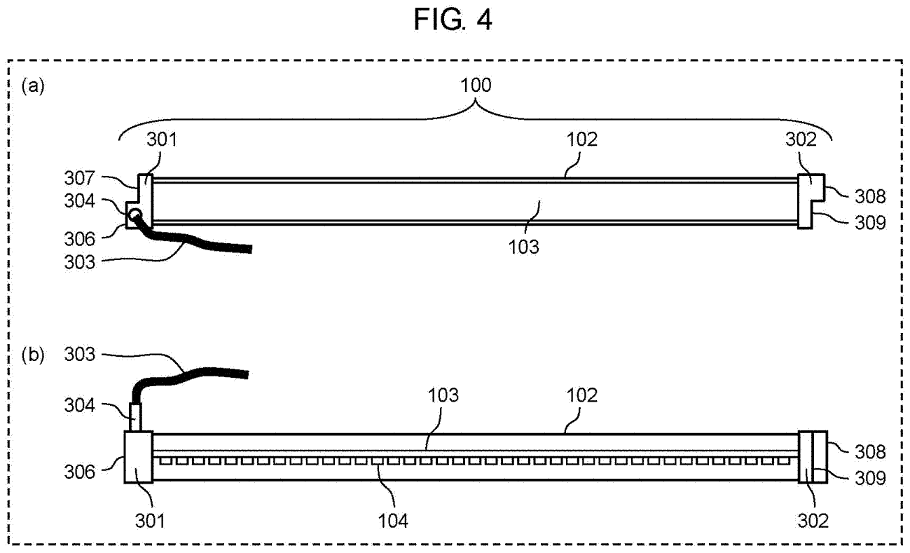

FIG. 4 illustrates an example of a configuration of LED lamp 100 in hydroponic growing according to the exemplary embodiment. LED lamp 100 includes power cable 303 that perpendicularly sticks out of LED lamp 100. Part (a) of FIG. 4 is an example of a top view that illustrates LED lamp 100 that includes power cable 303 that perpendicularly sticks out of LED lamp 100. Part (b) of FIG. 4 is an example of a side view that illustrates LED lamp 100 that includes power cable 303 that perpendicularly sticks out of LED lamp 100.

LED lamp 100 that includes power cable 303 that perpendicularly sticks out of LED lamp 100 includes first end cap 301, second end cap 302, and power cable 303.

LED lamp 100 that includes power cable 303 that perpendicularly sticks out of LED lamp 100 is supplied with electricity through power cable 303 or a power cord. In the present exemplary embodiment, an LED lamp that has such a configuration will be referred to as an LED lamp supplied with electricity through a power cable. LED lamp 100 that includes power cable 303 that perpendicularly sticks out of LED lamp 100 is a straight-bulb LED lamp and is cylindrical. When LED packages 104 face perpendicularly downward, power cable 303 perpendicularly sticks out of LED lamp 100 that includes power cable 303 that perpendicularly sticks out of LED lamp 100. That is to say, when LED packages 104 face perpendicularly downward, power cable 303 sticks out of LED lamp 100 perpendicularly to a surface of circuit board 103 of LED lamp 100. More specifically, power cable 303 is connected with a back surface of circuit board 103 at first end cap 301, as illustrated in FIG. 4.

First end cap 301 is a coupling device that is at one of two lengthwise ends of LED lamp 100 that includes power cable 303 that perpendicularly sticks out of LED lamp 100.

First end cap 301 has first protrusion 306, first depression 307, and cable passing portion 304.

First protrusion 306 is made on a surface of first end cap 301. To an opposite surface of first end cap 301, LED pipe 102 is attached. First protrusion 306 is semicircular, for example, when first protrusion 306 is seen along a longitudinal direction of the LED lamp.

First depression 307 is made on a surface of first end cap 301. To an opposite surface of first end cap 301, LED pipe 102 is attached. First depression 307 is an area of first end cap 301 that does not include the first protrusion. First depression 307 is semicircular, for example, when first depression 307 is seen along a longitudinal direction of the LED lamp.

Consequently, first end cap 301 has a configuration that has a shape like a letter “L” in a top view, as illustrated in part (a) of FIG. 4. That is to say, first end cap 301 has a cross section that is L-shaped. The cross section is parallel to circuit board 103 (one cross section that is parallel to a longitudinal direction of the LED lamp).

In the present exemplary embodiment, first protrusion 306 and first depression 307 constitute a first coupling part.

Power cable 303 of LED lamp 100 that includes power cable 303 that perpendicularly sticks out of LED lamp 100 passes through cable passing portion 304. As illustrated in parts (a) and (b) of FIG. 4, cable passing portion 304 is on a curved surface of first end cap 301. Power cable 303 perpendicularly passes through cable passing portion 304.

Second end cap 302 is a coupling device that is at one of two lengthwise ends of LED lamp 100 that includes power cable 303 that perpendicularly sticks out of LED lamp 100. First end cap 301 is at the other lengthwise end of LED lamp 100.

Second end cap 302 has second protrusion 308 and second depression 309.

Second protrusion 308 is made on a surface of second end cap 302. To an opposite surface of second end cap 302, LED pipe 102 is attached. Second protrusion 308 is semicircular, for example, when second protrusion 308 is seen along a longitudinal direction of the LED lamp.

Second depression 309 is made on a surface of second end cap 302. To an opposite surface of second end cap 302, LED pipe 102 is attached. Second depression 309 is an area of second end cap 302 that does not include second protrusion 308. Second depression 309 is semicircular, for example, when second depression 309 is seen along a longitudinal direction of the LED lamp.

Consequently, second end cap 302 has a configuration that has a shape like a letter “L” in a top view, as illustrated in part (a) of FIG. 4. That is to say, second end cap 302 has a cross section that is L-shaped. The cross section is parallel to circuit board 103 (one cross section that is parallel to a longitudinal direction of the LED lamp).

In the present exemplary embodiment, second protrusion 308 and second depression 309 constitute a second coupling part.

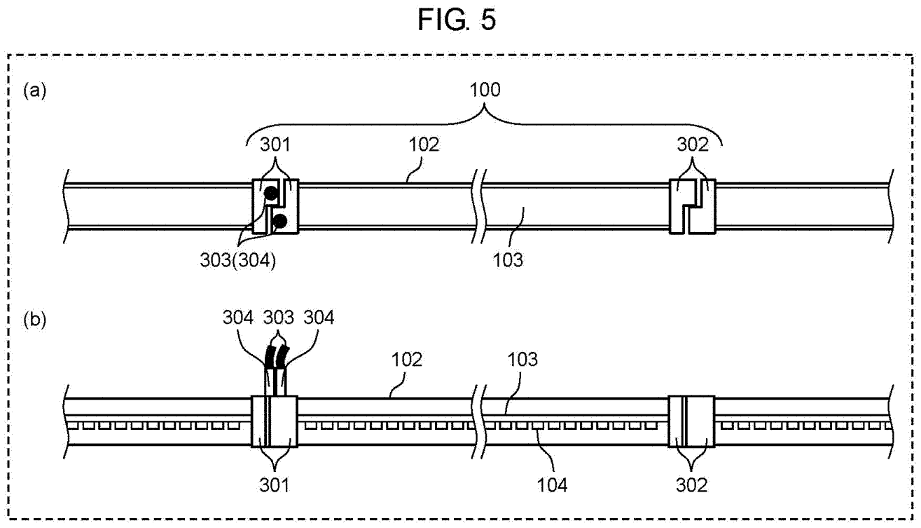

FIG. 5 illustrates an example of a plurality of LED lamps 100 coupled together by coupling units according to the exemplary embodiment. The plurality of LED lamps 100 each include power cable 303 that perpendicularly sticks out of each of the plurality of LED lamps 100. Part (a) of FIG. 5 is a top view that illustrates the plurality of LED lamps 100 coupled together by the coupling units. The plurality of LED lamps 100 each include power cable 303 that perpendicularly sticks out of each of the plurality of LED lamps 100. Part (b) of FIG. 5 is a side view that illustrates the plurality of LED lamps 100 coupled together by the coupling units. The plurality of LED lamps 100 each include power cable 303 that perpendicularly sticks out of each of the plurality of LED lamps 100.

Each of the coupling units includes a combination of two end caps. That is to say, each of the coupling units is coupling devices that are coupled together.

To couple one of two LED lamps 100 that each include power cable 303 that perpendicularly sticks out of each of two LED lamps 100 with another LED lamp 100 that includes power cable 303 that perpendicularly sticks out of the other LED lamp 100, first end cap 301 of the one of two LED lamps 100 that each include power cable 303 that perpendicularly sticks out of each of two LED lamps 100 is coupled with first end cap 301 of another LED lamp 100 that includes power cable 303 that perpendicularly sticks out of the other LED lamp 100, as illustrated in FIG. 5. At that time, first protrusion 306 of first end cap 301 of the one of two LED lamps 100 that each include power cable 303 that perpendicularly sticks out of each of two LED lamps 100 has a shape that corresponds to first depression 307 of first end cap 301 of another LED lamp 100 that includes power cable 303 that perpendicularly sticks out of the other LED lamp 100. The one of two LED lamps 100 that each include power cable 303 that perpendicularly sticks out of each of two LED lamps 100 is coupled with another LED lamp 100 that includes power cable 303 that perpendicularly sticks out of the other LED lamp 100 by first protrusion 306 of the one of two LED lamps 100 that each include power cable 303 that perpendicularly sticks out of each of two LED lamps 100 and first depression 307 of another LED lamp 100 that includes power cable 303 that perpendicularly sticks out of another LED lamp 100.

Further, first depression 307 of the one of two LED lamps 100 that each include power cable 303 that perpendicularly sticks out of each of two LED lamps 100 has a shape that corresponds to first protrusion 306 of another LED lamp 100 that includes power cable 303 that perpendicularly sticks out of the other LED lamp 100. The one of two LED lamps 100 that each include power cable 303 that perpendicularly sticks out of each of two LED lamps 100 is coupled with another LED lamp 100 that includes power cable 303 that perpendicularly sticks out of the other LED lamp 100 by first depression 307 of the one of two LED lamps 100 that each include power cable 303 that perpendicularly sticks out of each of two LED lamps 100 and first protrusion 306 of another LED lamp 100 that includes power cable 303 that perpendicularly sticks out of the other LED lamp 100.

Further, portions-through-which-a-power-cable-passes 304 of first end caps 301 of LED lamps 100 that each include power cable 303 that perpendicularly sticks out of each of LED lamps 100 allow power cable 303 to stick out of each of LED lamps 100 in a same direction, as illustrated in FIG. 5.

To couple one of two LED lamps 100 that each include power cable 303 that perpendicularly sticks out of each of two LED lamps 100 with another LED lamp 100 that includes power cable 303 that perpendicularly sticks out of another LED lamp 100, second end cap 302 of the one of two LED lamps 100 that each include power cable 303 that perpendicularly sticks out of each of two LED lamps 100 is coupled with second end cap 302 of the other LED lamp 100 that includes power cable 303 that perpendicularly sticks out of another LED lamp 100, as illustrated in FIG. 5. At that time, second protrusion 308 of second end cap 302 of the one of two LED lamps 100 that each include power cable 303 that perpendicularly sticks out of each of two LED lamps 100 is combined with second depression 309 of second end cap 302 of another LED lamp 100 that includes power cable 303 that perpendicularly sticks out of the other LED lamp 100. Further, second depression 309 of the one of two LED lamps 100 that each include power cable 303 that perpendicularly sticks out of each of two LED lamps 100 is combined with second protrusion 308 of another LED lamp 100 that includes power cable 303 that perpendicularly sticks out of another LED lamp 100.

In an example in FIG. 5, to couple one of two LED lamps 100 that each include power cable 303 that perpendicularly sticks out of each of two LED lamps 100 with another LED lamp 100 that includes power cable 303 that perpendicularly sticks out of the other LED lamp 100, first end cap 301 of the one of two LED lamps 100 that each include power cable 303 that perpendicularly sticks out of each of two LED lamps 100 is coupled with first end cap 301 of another LED lamp 100 that includes power cable 303 that perpendicularly sticks out of the other LED lamp 100. Alternatively, in the example in FIG. 5, to couple one of two LED lamps 100 that each include power cable 303 that perpendicularly sticks out of each of two LED lamps 100 with another LED lamp 100 that includes power cable 303 that perpendicularly sticks out of the other LED lamp 100, second end cap 302 of the one of two LED lamps 100 that each include power cable 303 that perpendicularly sticks out of each of two LED lamps 100 is coupled with second end cap 302 of another LED lamp 100 that includes power cable 303 that perpendicularly sticks out of the other LED lamp 100. On the other hand, first protrusion 306 of first end cap 301 of one of two LED lamps 100 that each include power cable 303 that perpendicularly sticks out of each of two LED lamps 100 may be coupled with second depression 309 of second end cap 302 of another LED lamp 100 that includes power cable 303 that perpendicularly sticks out of another LED lamp 100, as described later. Further, first depression 307 of first end cap 301 of the one of two LED lamps 100 that each include power cable 303 that perpendicularly sticks out of each of two LED lamps 100 may be coupled with second protrusion 308 of second end cap 302 of another LED lamp 100 that includes power cable 303 that perpendicularly sticks out of another LED lamp 100, as described later. That is to say, to couple together two LED lamps 100 that each include power cable 303 that perpendicularly sticks out of each of two LED lamps 100, first end cap 301 of one of two LED lamps 100 that each include power cable 303 that perpendicularly sticks out of each of two LED lamps 100 may be coupled with second end cap 302 of another LED lamp 100 that includes power cable 303 that perpendicularly sticks out of another LED lamp 100.

[1-2. Configuration of LED Lamp that Includes Power Cable that Horizontally Sticks Out of LED Lamp]

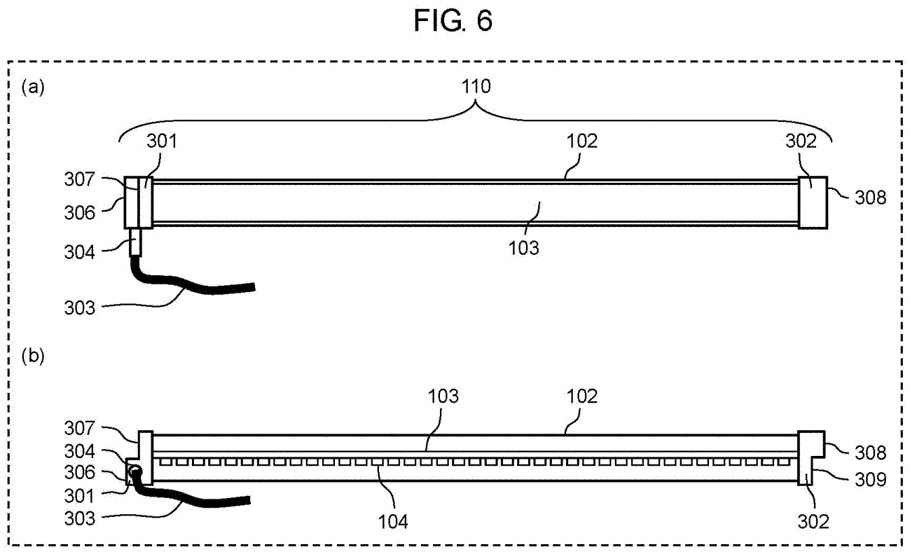

FIG. 6 illustrates an example of a configuration of LED lamp 110 in hydroponic growing according to the exemplary embodiment. LED lamp 110 includes power cable 303 that horizontally sticks out of LED lamp 110. Part (a) of FIG. 6 is an example of a top view that illustrates LED lamp 110 that includes power cable 303 that horizontally sticks out of LED lamp 110. Part (b) of FIG. 6 is an example of a side view that illustrates LED lamp 110 that includes power cable 303 that horizontally sticks out of LED lamp 110.

A difference between LED lamp 110 that includes power cable 303 that horizontally sticks out of LED lamp 110 and LED lamp 100 that includes power cable 303 that perpendicularly sticks out of LED lamp 100 is that when LED packages 104 face perpendicularly downward, a direction in which power cable 303 sticks out of LED lamp 110 is horizontal, and the direction is also perpendicular to a longitudinal direction of LED lamp 101, as illustrated in FIG. 6. More specifically, power cable 303 is connected with a side of circuit board 103 at first end cap 301, as illustrated in FIG. 6.

Another difference between LED lamp 110 that includes power cable 303 that horizontally sticks out of LED lamp 110 and LED lamp 100 that includes power cable 303 that perpendicularly sticks out of LED lamp 100 is that first protrusion 306 is part of a lower portion of first end cap 301 and first depression 307 is part of an upper portion of first end cap 301, as illustrated in part (b) of FIG. 6. Further, second protrusion 308 is part of an upper portion of second end cap 302. Second depression 309 is part of a lower portion of second end cap 302. That is to say, if first end cap 301 of LED lamp 100 that includes power cable 303 that perpendicularly sticks out of LED lamp 100 is rotated 90° relative to LED pipe 102, first end cap 301 that has been rotated corresponds to first end cap 301 of LED lamp 110 that includes power cable 303 that horizontally sticks out of LED lamp 110. Further, if second end cap 302 of LED lamp 100 that includes power cable 303 that perpendicularly sticks out of LED lamp 100 is rotated 90° relative to LED pipe 102, second end cap 302 that has been rotated corresponds to second end cap 302 of LED lamp 110 that includes power cable 303 that horizontally sticks out of LED lamp 110. First protrusion 306 may be part of an upper portion of first end cap 301. First depression 307 may be part of a lower portion of first end cap 301. Second protrusion 308 may be part of a lower portion of second end cap 302. Second depression 309 may be part of an upper portion of second end cap 302.

Consequently, first end cap 301 and second end cap 302 each have a configuration that has a shape like a letter “L” in a side view, as illustrated in part (b) of FIG. 6. That is to say, LED lamp 110 that includes power cable 303 that horizontally sticks out of LED lamp 110 has first end cap 301 and second end cap 302 that each have a cross section that is L-shaped. The cross section is parallel to a longitudinal direction of the LED lamp and is perpendicular to circuit board 103.

Further, another difference between LED lamp 110 that includes power cable 303 that horizontally sticks out of LED lamp 110 and LED lamp 100 that includes power cable 303 that perpendicularly sticks out of LED lamp 100 is that power cable 303 horizontally passes through cable passing portion 304 of first end cap 301 of LED lamp 110 that includes power cable 303 that horizontally sticks out of LED lamp 110.

Other configurations of LED lamp 110 that includes power cable 303 that horizontally sticks out of LED lamp 110 are same as other configurations of LED lamp 100 that includes power cable 303 that perpendicularly sticks out of LED lamp 100. Therefore, the other configurations will not be described.

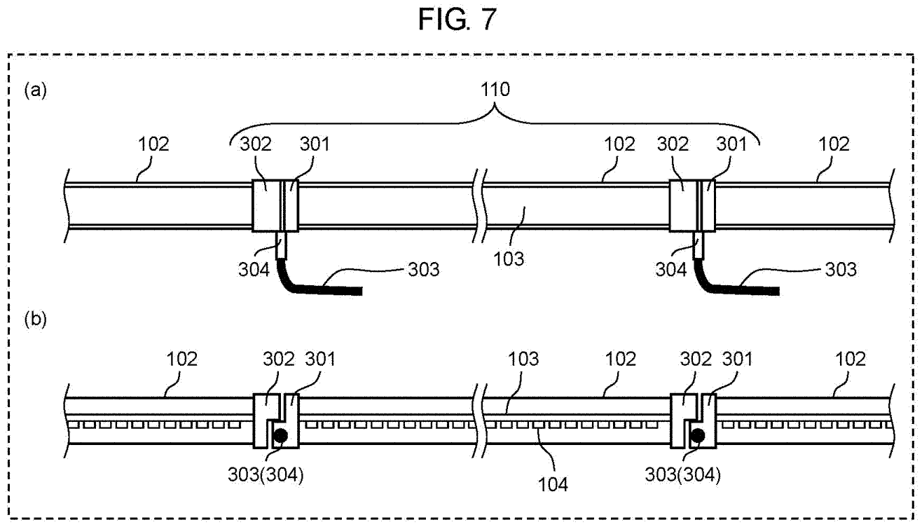

FIG. 7 illustrates an example of a plurality of LED lamps 110 that each include power cable 303 that horizontally sticks out of each of the plurality of LED lamps 110. In FIG. 7, the plurality of LED lamps 110 that each include power cable 303 that horizontally sticks out of each of the plurality of LED lamps 110 are coupled together by coupling units according to the exemplary embodiment. Part (a) of FIG. 7 is a top view that illustrates the plurality of LED lamps 110 that each include power cable 303 that horizontally sticks out of each of the plurality of LED lamps 110. In part (a) of FIG. 7, the plurality of LED lamps 110 that each include power cable 303 that horizontally sticks out of each of the plurality of LED lamps 110 are coupled together by the coupling units. Part (b) of FIG. 7 is a side view that illustrates the plurality of LED lamps 110 that each include power cable 303 that horizontally sticks out of each of the plurality of LED lamps 110. In part (b) of FIG. 7, the plurality of LED lamps 110 that each include power cable 303 that horizontally sticks out of each of the plurality of LED lamps 110 are coupled together by the coupling units.

As illustrated in FIG. 7, to couple one of two LED lamps 110 that each include power cable 303 that horizontally sticks out of each of two LED lamps 110 with another LED lamp 110 that includes power cable 303 that horizontally sticks out of the other LED lamp 110, first protrusion 306 of first end cap 301 of the one of two LED lamps 110 that each include power cable 303 that horizontally sticks out of each of two LED lamps 110 is coupled with second depression 309 of second end cap 302 of another LED lamp 110 that includes power cable 303 that horizontally sticks out of the other LED lamp 110, and first depression 307 of first end cap 301 of the one of two LED lamps 110 that each include power cable 303 that horizontally sticks out of each of two LED lamps 110 is coupled with second protrusion 308 of second end cap 302 of another LED lamp 110 that includes power cable 303 that horizontally sticks out of another LED lamp 110. That is to say, to couple one of two LED lamps 110 that each include power cable 303 that horizontally sticks out of each of two LED lamps 110 with another LED lamp 110 that includes power cable 303 that horizontally sticks out of the other LED lamp 110, first end cap 301 of the one of two LED lamps 110 that each include power cable 303 that horizontally sticks out of each of two LED lamps 110 is coupled with second end cap 302 of another LED lamp 110 that includes power cable 303 that horizontally sticks out of another LED lamp 110.

### [2. Shapes of End Caps]

Detailed configurations of first end cap 301 and second end cap 302 that constitute a coupling unit according to the exemplary embodiment will be described.

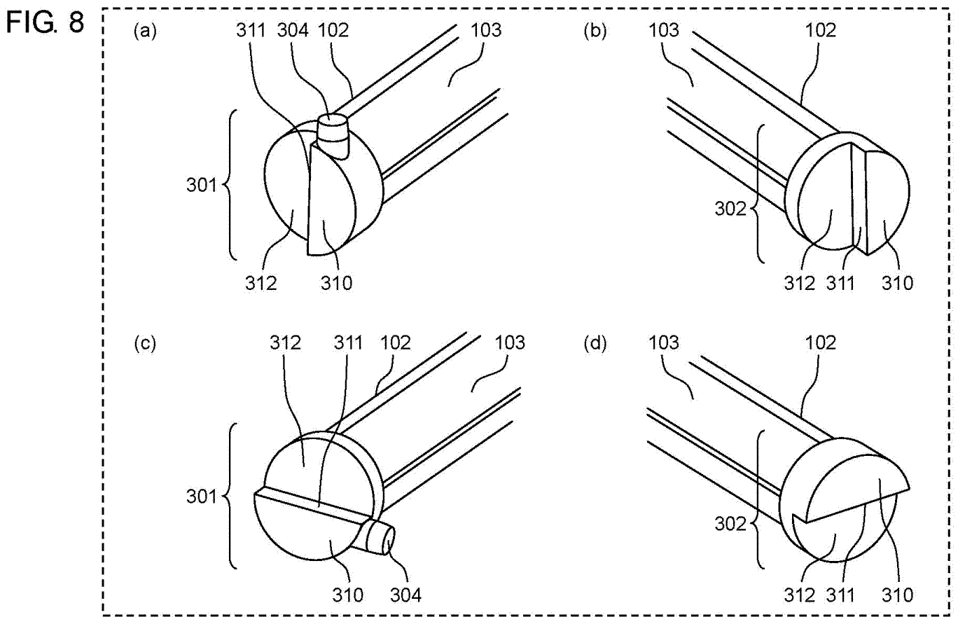

FIG. 8 illustrates examples of first shapes of end caps according to the exemplary embodiment. Part (a) of FIG. 8 is an example of shapes of first end cap 301 of LED lamp 100 that includes power cable 303 that perpendicularly sticks out of LED lamp 100. Part (b) of FIG. 8 is an example of shapes of second end cap 302 of LED lamp 100 that includes power cable 303 that perpendicularly sticks out of LED lamp 100. Part (c) of FIG. 8 is an example of shapes of first end cap 301 of LED lamp 110 that includes power cable 303 that horizontally sticks out of LED lamp 110. Part (d) of FIG. 8 is an example of shapes of second end cap 302 of LED lamp 110 that includes power cable 303 that horizontally sticks out of LED lamp 110.

In LED lamp 100 that includes power cable 303 that perpendicularly sticks out of LED lamp 100, each of first end cap 301 and second end cap 302 includes first surface 310, second surface 311, and third surface 312. First surface 310, second surface 311, and third surface 312 are coupled with respective corresponding surfaces. Further, in LED lamp 110 that includes power cable 303 that horizontally sticks out of LED lamp 110, each of first end cap 301 and second end cap 302 includes first surface 310, second surface 311, and third surface 312. First surface 310, second surface 311, and third surface 312 are coupled with respective corresponding surfaces.

First surface 310 of an LED lamp is substantially perpendicular to a longitudinal direction of the LED lamp. When two end caps are coupled together, first surface 310 of one of the two end caps is attached to third surface 312 of the other end cap.

Second surface 311 of an LED lamp is substantially parallel to a longitudinal direction of the LED lamp. In LED lamp 100 that includes power cable 303 that perpendicularly sticks out of LED lamp 100, second surface 311 is perpendicular. In LED lamp 110 that includes power cable 303 that horizontally sticks out of LED lamp 110, second surface 311 is horizontal. When two end caps are coupled together, second surface 311 of one of the two end caps is attached to second surface 311 of the other end cap.

Third surface 312 of LED lamp is substantially perpendicular to a longitudinal direction of LED lamp. When two end caps are coupled together, third surface 312 of one of the two end caps is attached to first surface 310 of the other end cap.

As illustrated in FIG. 8, second surface 311 is adjacent to each of first surface 310 and third surface 312. Therefore, first end cap 301 and second end cap 302 each have a protrusion formed by first surface 310 and second surface 311. Further, first end cap 301 and second end cap 302 each have a depression formed by second surface 311 and third surface 312. Consequently, first end cap 301 and second end cap 302 each is L-shaped.

Further, cable passing portion 304 is on a curved surface of the first end cap 301. Cable passing portion 304 is along second surface 311.

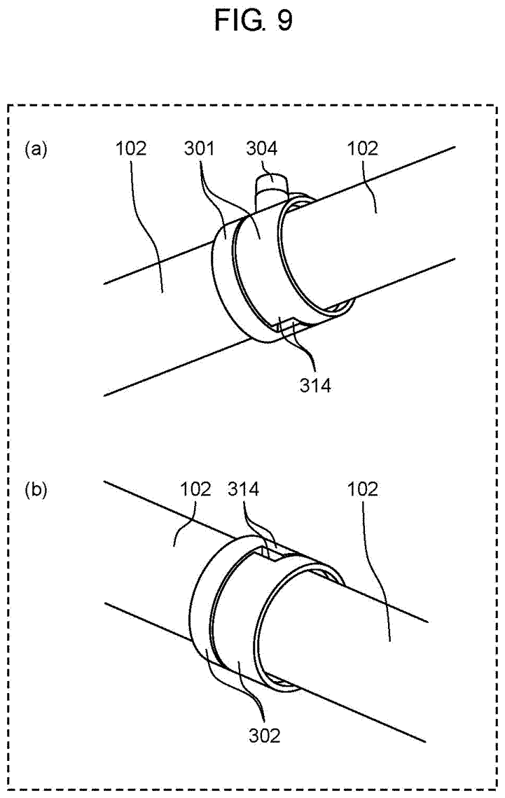

FIG. 9 illustrates an example of end caps coupled together. The end caps have the respective first shapes according to the exemplary embodiment. Part (a) of FIG. 9 illustrates first end caps 301 coupled together. First end caps 301 have the respective first shapes. Each of first end caps 301 is part of LED lamp 100 that includes power cable 303 that perpendicularly sticks out of LED lamp 100. Part (b) of FIG. 9 illustrates second end caps 302 coupled together. Second end caps 302 have the respective first shapes. Each of second end caps 302 is part of LED lamp 100 that includes power cable 303 that perpendicularly sticks out of LED lamp 100.

As described with reference to FIGS. 5, 7, and 8, when one of two end caps is coupled to the other end cap, a protrusion of the one of two end caps corresponds to a depression of the other end cap. Further, a depression of the one of two end caps corresponds to a protrusion of the other end cap. Therefore, rotation of the LED lamps is restricted. A small gap is between second surfaces 311 of the end caps, as illustrated in FIG. 9. However, if one of the LED lamps rotates, edges 314 of the end caps come into contact with each other. Consequently, the rotation of the one of the LED lamps is restricted.

### [3. Advantageous Effects]

As described above, in the exemplary embodiment, a coupling unit includes first end cap 301 attached to one of two LED lamps each supplied with electricity through respective power cables, and first end cap 301 attached to the other LED lamp supplied with electricity through a power cable. Alternatively, in the exemplary embodiment, a coupling unit includes first end cap 301 attached to one of two LED lamps each supplied with electricity through respective power cables, and second end cap 302 attached to the other LED lamp supplied with electricity through a power cable. First end cap 301 has a first coupling part that has first protrusion 306 and first depression 307. Second end cap 302 has a second coupling part that has second protrusion 308 and second depression 309. Second protrusion 308 corresponds to first depression 307. Second depression 309 corresponds to first protrusion 306.

Therefore, in case of LED lamps each supplied with electricity through respective power cables, illuminance between the LED lamps coupled together is more even. More specifically, in case of LED lamps 101 each supplied with electricity through bases of each of LED lamps 101, a distance between LED packages 104 is increased by widths of sockets 201 and widths of sealing rings 204. In the present exemplary embodiment, however, sockets 201 are not used since LED lamps each supplied with electricity through respective power cables are used. Therefore, a distance between LED packages 104 in the present exemplary embodiment is shorter than a distance between LED packages 104 of LED lamps 101 each supplied with electricity through bases of each of LED lamps 101.

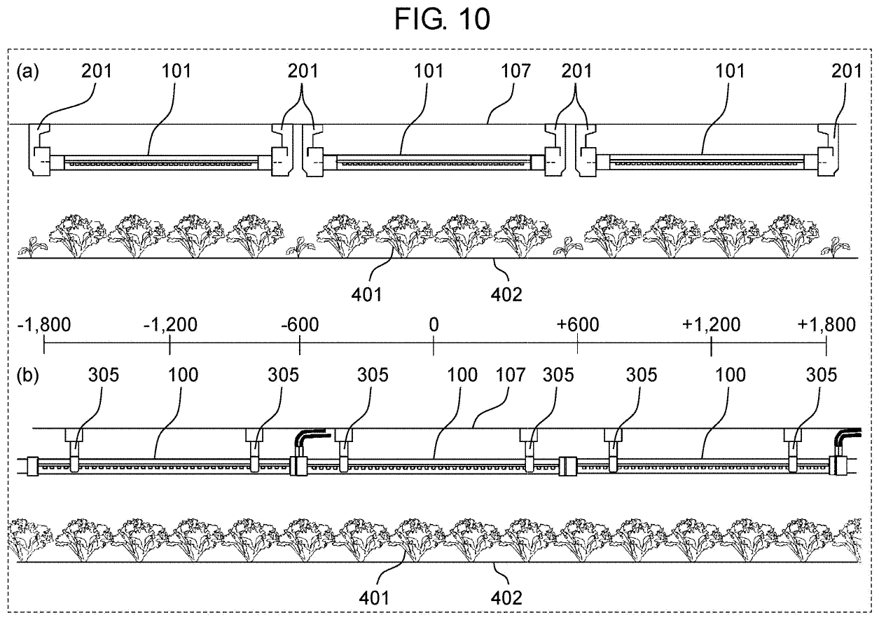

FIG. 10 illustrates an example in which an arrangement of LED lamps in hydroponic growing according to the exemplary embodiment is compared with an arrangement of LED lamps in conventional hydroponic growing. Part (a) of FIG. 10 illustrates an arrangement of LED lamps 101 in conventional hydroponic growing. In part (a) of FIG. 10, LED lamps 101 are each supplied with electricity through bases of each of LED lamps 101. Part (b) of FIG. 10 illustrates an arrangement of LED lamps 100 in hydroponic growing according to the exemplary embodiment. In part (b) of FIG. 10, LED lamps 100 each include a power cable that perpendicularly sticks out of each of LED lamps 100. Further, LED lamps 100 are each supplied with electricity through the respective power cables.

As illustrated in part (a) of FIG. 10, LED lamps 101 each supplied with electricity through bases of each of LED lamps 101 are used in conventional hydroponic growing. In that case, illuminance of light between socket 201 to which one of LED lamps 101 is attached and socket 201 to which one of LED lamps 101 is attached is lower than illuminance of light at a central portion of each of LED lamps 101. Consequently, plants 401 do not grow evenly in conventional hydroponic growing.

On the other hand, in hydroponic growing according to the exemplary embodiment, base pins 106 and sockets 201 are not used since LED lamps each supplied with electricity through respective power cables are used, as illustrated in part (b) of FIG. 10. Each of coupling units includes first end caps 301 or second end caps 302. First end caps 301 or second end caps 302 are used to couple together LED lamps each supplied with electricity through respective power cables. Therefore, a length of base pins 106 and a width of sockets 201 do not influence the coupling units.

Therefore, the coupling units according to the present exemplary embodiment reduce a distance between LED lamps coupled together. The LED lamps are each supplied with electricity through respective power cables. In that case, holders 305 hold LED lamps 100 at respective predetermined positions. LED lamps 100 each include power cable 303 that perpendicularly sticks out of each of LED lamps 100.

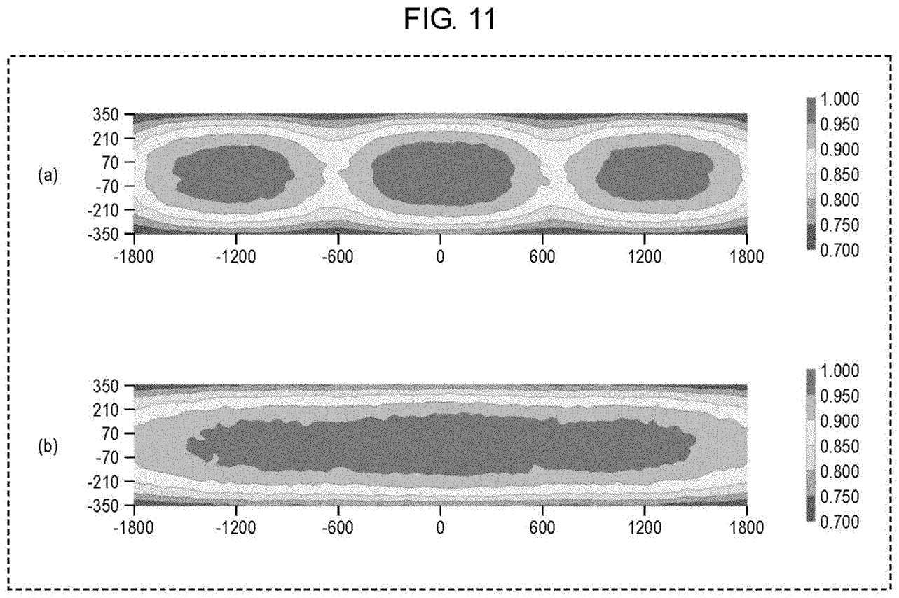

FIG. 11 is a drawing in which a distribution of illuminance provided by LED lamps 101 arranged in hydroponic growing according to the exemplary embodiment is compared with a distribution of illuminance provided by LED lamps 101 arranged in conventional hydroponic growing. FIG. 11 illustrates relative illuminance. In FIG. 11, a maximum value of the relative illuminance is one. Part (a) of FIG. 11 illustrates an example of a distribution of illuminance provided by LED lamps 101 arranged in the conventional hydroponic growing. Part (b) of FIG. 11 illustrates an example of a distribution of illuminance provided by LED lamps 100 arranged in the hydroponic growing according to the exemplary embodiment.

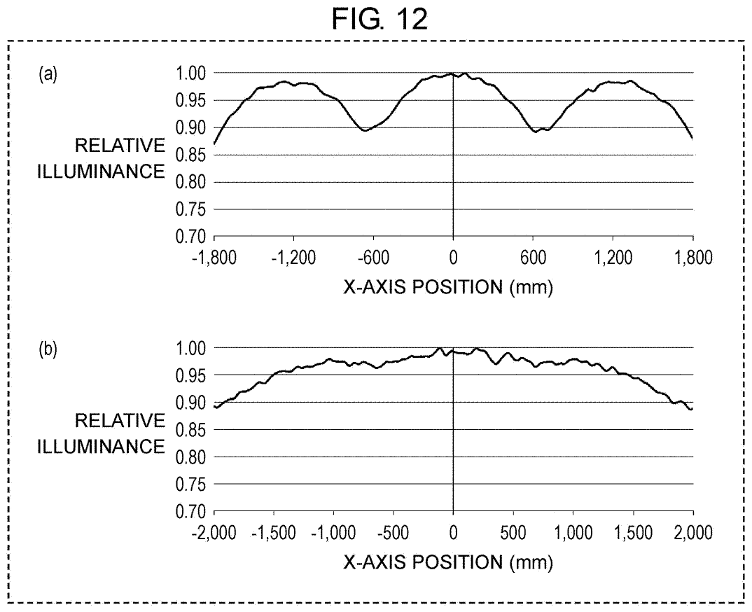

FIG. 12 includes graphs by which illuminance provided by LED lamps arranged in the hydroponic growing according to the exemplary embodiment is compared with illuminance provided by LED lamps arranged in the conventional hydroponic growing. FIG. 12 illustrates relative illuminance. In FIG. 12, a maximum value of the relative illuminance is one. FIG. 12 is graphs obtained by plotting relative illuminance in FIG. 11 on FIG. 12. The relative illuminance in FIG. 11 that is plotted on FIG. 12 is relative illuminance along a horizontal central line in FIG. 11. FIG. 11 illustrates a two-dimensional distribution of illuminance. Part (a) of FIG. 12 is a graph that illustrates an example of illuminance provided by LED lamps 101 arranged in the conventional hydroponic growing. Part (b) of FIG. 12 is a graph that illustrates an example of illuminance provided by LED lamps 100 arranged in the hydroponic growing according to the exemplary embodiment.

FIGS. 11 and 12 illustrate illuminance that has been calculated. The illuminance corresponds to photosynthetic photon flux density (PPFD) widely used in a field of hydroponic growing.

At X-axis positions of ±600 in each of part (a) of FIG. 11 and part (a) of FIG. 12, base pins 106 and sockets 201 of LED lamps 101 each supplied with electricity through bases of each of LED lamps 101 are arranged. As illustrated in part (a) of FIG. 11 and part (a) of FIG. 12, illuminance of light between socket 201 to which one of LED lamps 101 each supplied with electricity through bases of each of LED lamps 101 is attached and socket 201 to which one of LED lamps 101 each supplied with electricity through bases of each of LED lamps 101 is attached is lower than illuminance of light at an X-axis position of zero. The X-axis position of zero is one of centers of LED lamps 101 each supplied with electricity through bases of each of LED lamps 101. That is to say, illuminance of light is not even if LED lamps 101 attached to sockets 201 are used.

On the other hand, at X-axis positions of ±600 in each of part (b) of FIG. 11 and part (b) of FIG. 12, coupling units according to the exemplary embodiment are used. The coupling units couple together LED lamps 100 each supplied with electricity through respective power cables. Consequently, as illustrated in part (b) of FIG. 11 and part (b) of FIG. 12, illuminance of light is more even in the exemplary embodiment.

More specifically, a calculated quantity of light under a center of one of the LED lamps (an X-axis position of zero) is 12,000 lux in terms of illuminance, and is 230 μmol·m⁻²·s⁻¹b in terms of PPFD, for example. Suppose that relative illuminance is 1.00 at the X-axis position of zero. In that case, in each of part (a) of FIG. 11 and part (a) of FIG. 12, relative illuminance is 0.90 at X-axis positions of ±600 between socket 201 and socket 201. On the other hand, in each of part (b) of FIG. 11 and part (b) of FIG. 12, relative illuminance is 0.95 or higher at X-axis positions of ±600.

Further, each of coupling units in the exemplary embodiment includes two end caps. A shape of a protrusion of one of the two end caps corresponds to a depression of the other end cap. Further, a shape of a depression of the one of the two end caps corresponds to a protrusion of the other end cap.

Consequently, each of the coupling units restrict rotation of LED lamps.

In case of LED lamps 101 each supplied with electricity through bases of each of LED lamps 101, a direction in which each of LED lamps 101 emits light is adjusted by rotating each of LED lamps 101 on a central axis of each of LED lamps 101. In the present exemplary embodiment, the coupling units are used. Therefore, a rotational direction of only one of LED lamps 101 is adjusted, and then end caps of the other LED lamps 101 are coupled together. Consequently, rotational deviations of the other LED lamps 101 are restricted.

Further, each of coupling units in the exemplary embodiment may include cable passing portion 304 at first end cap 301. Power cable 303 of each of LED lamps passes through cable passing portion 304.

Consequently, each of power cables 303 sticks out between LED lamps coupled together. Further, each of cables 303 sticks out in an intended direction.

Each of coupling units in the exemplary embodiment may include two end caps that have a same configuration. That is to say, to couple one of two LED lamps 100 that each include power cable 303 that perpendicularly sticks out of each of two LED lamps 100 with the other LED lamp 100 that includes power cable 303 that perpendicularly sticks out of the other LED lamp 100, first end cap 301 of the one of two LED lamps 100 that each include power cable 303 that perpendicularly sticks out of each of two LED lamps 100 may be coupled with first end cap 301 of another LED lamp 100 that includes power cable 303 that perpendicularly sticks out of another LED lamp 100. Alternatively, to couple one of two LED lamps 100 that each include power cable 303 that perpendicularly sticks out of each of two LED lamps 100 with another LED lamp 100 that includes power cable 303 that perpendicularly sticks out of the other LED lamp 100, second end cap 302 of the one of two LED lamps 100 that each include power cable 303 that perpendicularly sticks out of each of two LED lamps 100 may be coupled with second end cap 302 of another LED lamp 100 that includes power cable 303 that perpendicularly sticks out of the other LED lamp 100.

Consequently, power cables 303 of LED lamps 100 stick out of respective first end caps that are adjacent to each other. Therefore, power cables 303 of LED lamps 100 are easily wired.

### [4. Examples of Second Shapes of End Caps]

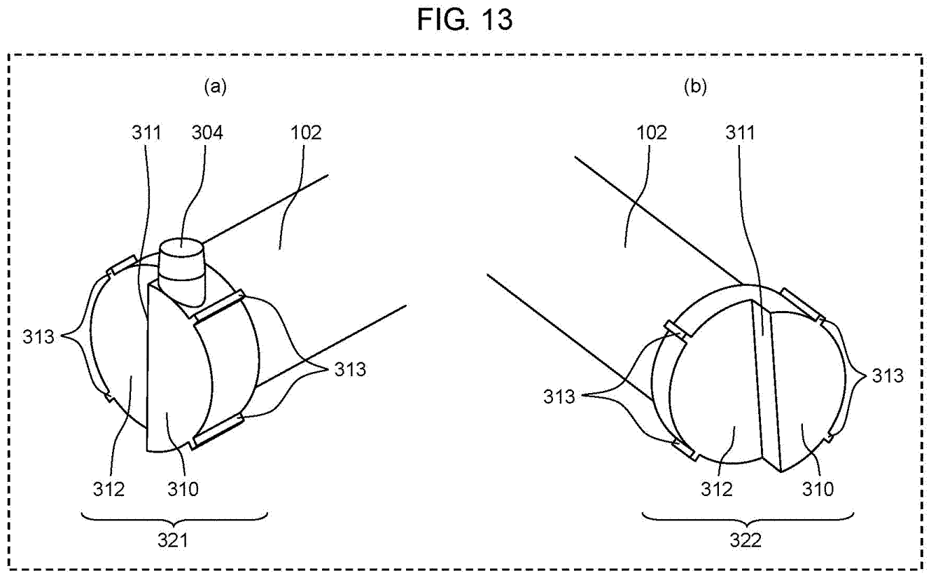

FIG. 13 illustrates examples of second shapes of end caps according to the present exemplary embodiment. Part (a) of FIG. 13 illustrates an example of second shapes of first end cap 321 according to the present exemplary embodiment. Part (b) of FIG. 13 illustrates an example of second shapes of second end cap 322 according to the present exemplary embodiment.

A difference between the first shapes and the second shapes is that each of end caps has projections 313 on a curved surface of the end cap.

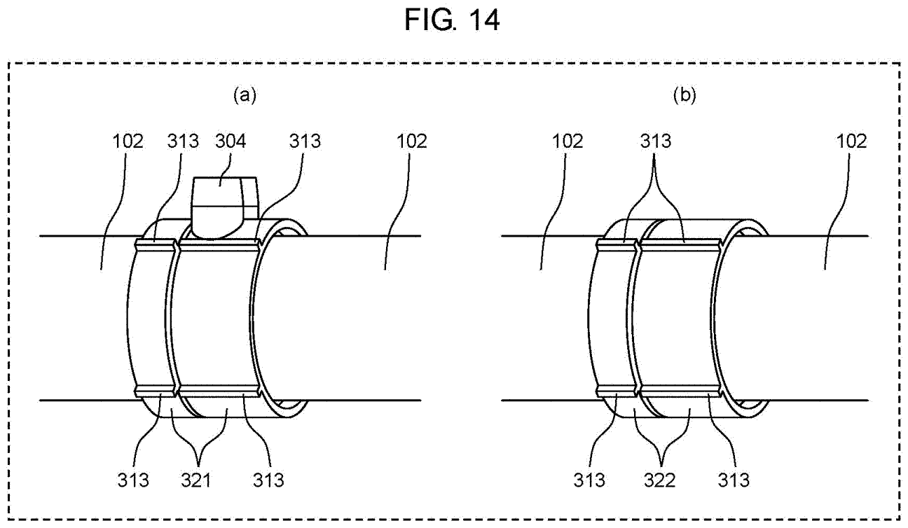

FIG. 14 illustrates an example of end caps attached to each other. The end caps have the respective second shapes according to the present exemplary embodiment. Part (a) of FIG. 14 illustrates an example of first end caps 321 attached to each other. First end caps 321 have the respective second shapes. Part (b) of FIG. 14 illustrates an example of second end caps 322 attached to each other. Second end caps 322 have the respective second shapes.

As illustrated in FIG. 14, projections 313 may be used as markers when LED lamps are coupled together.

More specifically, projections 313 may be used as markers in such a manner that projections 313 of one of two end caps align with projections 313 of the other end cap, respectively.

In FIGS. 13 and 14, four projections 313 are at regular intervals on a curved surface of each of the end caps. However, a number of projections 313 is not limited to four. The number of projections 313 may be one or a plural number.

### [5. Examples of Third Shapes of End Caps]

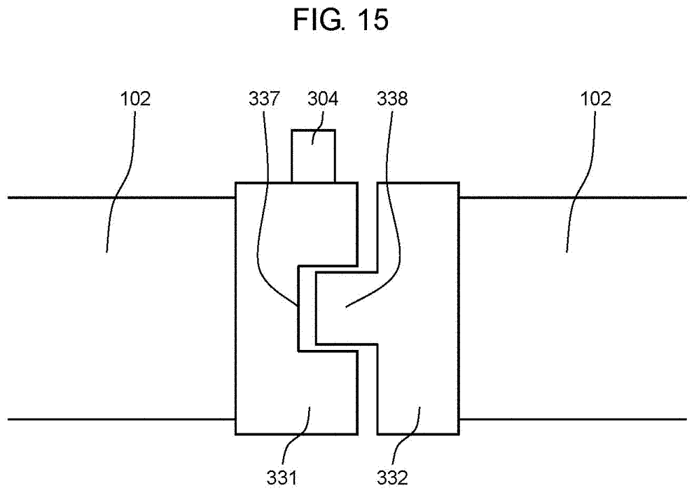

FIG. 15 illustrates examples of third shapes of end caps according to the exemplary embodiment.

As illustrated in a side view of FIG. 15, a shape of first end cap 331 is a depression, and a shape of second end cap 332 is a protrusion. For example, first end cap 331 has first depression 337, and second end cap 332 has second protrusion 338. Second protrusion 338 of second end cap 332 is coupled with first depression 337 of first end cap 331. That is to say, first end cap 331 and second end cap 332 each do not have such a shape like a letter “L” as illustrated in FIG. 8. First end cap 331 has the depression at a central portion of first end cap 331, as illustrated in FIG. 15. Second end cap 332 has the protrusion at a central portion of second end cap 332, as illustrated in FIG. 15. In that case, the first end cap has at least one cross section having a depressed shape. The at least one cross section is parallel to a longitudinal direction of the LED lamp. Further, the second end cap has at least one cross section having a protruded shape. The at least one cross section is parallel to a longitudinal direction of the LED lamp.

Alternatively, a first end cap may have a first protrusion at a central portion of the first end cap, in a side view. Further, a second end cap may have a second depression at a central portion of the second end cap, in a side view. The first protrusion of the first end cap may be coupled with the second depression of the second end cap. In that case, the first end cap has at least one cross section having a protruded shape. The at least one cross section is parallel to a longitudinal direction of the LED lamp. Further, the second end cap has at least one cross section having a depressed shape. The at least one cross section is parallel to a longitudinal direction of the LED lamp. Further, the first protrusion of the first end cap may have cable passing portion 304.

### [6. Examples of Fourth Shapes of End Caps]

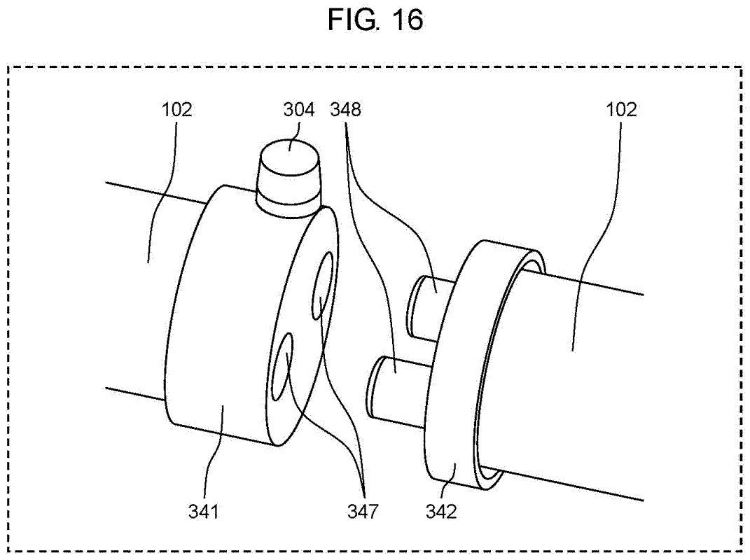

FIG. 16 is a perspective view that illustrates examples of fourth shapes of end caps according to the present exemplary embodiment.

First end cap 341 has a plurality of depressions. Further, second end cap 342 has a plurality of protrusions. For example, first end cap 341 has two first depressions 347, as illustrated in FIG. 16. For example, second end cap 342 has two second protrusions 348, as illustrated in FIG. 16. Second protrusions 348 of second end cap 342 are coupled with first depressions 347 of first end cap 341, respectively. That is to say, first end cap 341 and second end cap 342 in FIG. 16 each do not have such a shape like a letter “L” as illustrated in FIG. 8. First end cap 341 has the plurality of depressions. Second end cap 342 has the plurality of protrusions.

In FIG. 16, only first end cap 341 has cable passing portion 304. However, second end cap 342 may also have cable passing portion 304.

In FIG. 16, first end cap 341 has two first depressions 347, and second end cap 342 has two second protrusions 348. However, a number of first depressions 347 is not limited to two. Further, a number of second protrusions 348 is not limited to two. The number of depressions of first end cap 341 may be any plural number, and the number of protrusions of second end cap 342 may be any plural number if the number of depressions is equal to the number of protrusions.

### [7. Others]

The present invention and inventions related to the present invention have been described above. However, things described above do not limit the present invention and the inventions related to the present invention. The things described above are variously modified within the spirit of the present invention and the inventions related to the present invention.

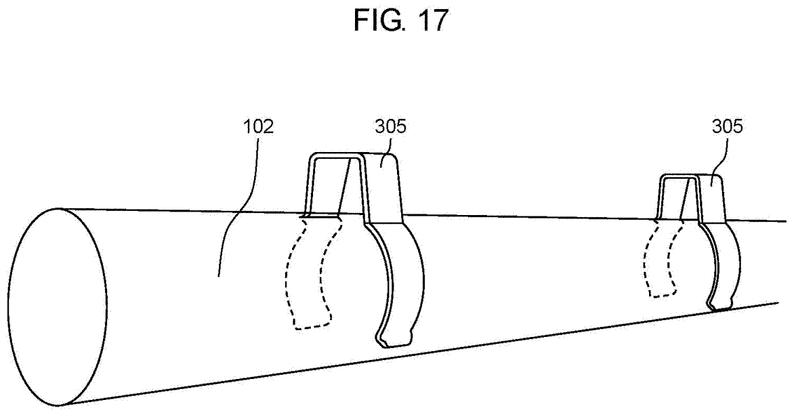

Holders 305 may be arranged to hold LED lamps at respective predetermined positions. The LED lamps may each include a power cable that perpendicularly sticks out of each of the LED lamps. Alternatively, the LED lamps may each include a power cable that horizontally sticks out of each of the LED lamps. FIG. 17 illustrates an example of holders 305 that hold the LED lamps according to the exemplary embodiment. As illustrated in FIG. 17, holders 305 are arranged along a curved surface of LED pipe 102 of a LED lamp. Holders 305 hold LED pipe 102. The LED lamp may include a power cable that perpendicularly sticks out of the LED lamp. Alternatively, the LED lamp may include a power cable that horizontally sticks out of the LED lamp.

In the present exemplary embodiment, each of coupling units includes two end caps. A protrusion of one of the two end caps enters a depression of the other end cap. A protrusion of the other end cap enters a depression of the one of the two end caps. However, the protrusions are not necessarily tightly in contact with the depressions. That is to say, first surface 310 of the one of two end caps is not necessarily tightly in contact with third surface 312 of the other end cap. Further, second surface 311 of the one of two end caps is not necessarily tightly in contact with second surface 311 of the other end cap. Further, third surface 312 of the one of two end caps is not necessarily tightly in contact with first surface 310 of the other end cap. Therefore, there may be play between the protrusion of the one of two end caps and the depression of the other end cap. Further, there may be play between the depression of the one of two end caps and the protrusion of the other end cap.

The play means a space that allows end caps of a coupling unit to rotate approximately ±10°, for example.

A height of a protrusion of each of a first end cap and a second end cap may be larger than or equal to 2 mm. The height of the protrusion is a length of a side of second surface 311. The side of second surface 311 is perpendicular to both first surface 310 and third surface 312. Therefore, even if end caps of a coupling unit rotate, second surface 311 of one of the end caps comes into contact with edge 314 of the other end cap. That is to say, second surface 311 of the one of the end caps comes into contact with the edge of a protrusion. Consequently, the end caps do not rotate further. Therefore, rotation of the end caps is restricted.

In the above description of the present exemplary embodiment, LED lamps are each supplied with electricity through respective power cables. Further, the power cables perpendicularly stick out of the respective LED lamps. Alternatively, the power cables horizontally stick out of the respective LED lamps. However, power cables do not necessarily perpendicularly or horizontally stick out of respective LED lamps.

### INDUSTRIAL APPLICABILITY

Coupling units and coupling devices according to an aspect of the present disclosure are used, for example, in hydroponic growing in which a plurality of LED lamps are used. In that case, illuminance between LED lamps increases. Consequently, plants grow more evenly. Therefore, the coupling units and the coupling devices are useful. Further, work required for attaching LED lamps to respective sockets decreases. Therefore, the coupling units and the coupling devices are useful.

What is claimed is:

1. A coupling unit comprising:
a first coupling device attached to a first lighting device supplied with electricity through a power cable; and
a second coupling device attached to a second lighting device supplied with electricity through a power cable, wherein
the first coupling device has a first coupling part that couples with the second coupling device, and a first projection provided on a part different from the first coupling part,
the second coupling device has a second coupling part that couples with the first coupling device, and a second projection provided on a part different from the second coupling part,
the first coupling part has at least one cross section that is L-shaped, and the at least one cross section being parallel to a longitudinal direction of the first lighting device,
the first projection is perpendicular to the longitudinal direction of the first lighting device,
the second coupling part has at least one cross section that is L-shaped, and the at least one cross section being parallel to a longitudinal direction of the second lighting device, and
the second projection is perpendicular to the longitudinal direction of the second lighting device.

2. The coupling unit according to claim 1, wherein when the first coupling device is coupled with the second coupling device, a gap is between the first coupling part and the second coupling part.

3. The coupling unit according to claim 1, wherein
the first coupling device has a cable passing portion through which the power cable of the first lighting device passes, and the cable passing portion provided on a part different from the first coupling part, and
the second coupling device has a cable passing portion through which the power cable of the second lighting device passes, and the cable passing portion provided on a part different from the second coupling part.

4. The coupling unit according to claim 1, wherein
the first coupling device has a cable passing portion through which the power cable of the first lighting device passes, and the cable passing portion provided on a part different from the first coupling part, and
the second coupling device does not have a cable passing portion through which the power cable of the second lighting device passes.

5. A coupling device that is attached to a lighting device supplied with electricity through a power cable, and is for coupling with a different coupling device attached to a different lighting device supplied with electricity through a power cable, the coupling device comprising:
a coupling part that couples with the different coupling device; and
a projection that is provided on a part different from the coupling part, wherein
the coupling part has a coupling depression that corresponds to a protrusion of the different coupling device and a coupling protrusion that corresponds to a depression of the different coupling device, and
the projection is perpendicular to a longitudinal direction of the lighting device.

6. The coupling device according to claim 5, wherein when the coupling device is coupled with the different coupling device, a gap is between the protrusion of the different coupling device and the coupling depression, and a gap is between the depression of the different coupling device and the coupling protrusion.

7. The coupling device according to claim 5, wherein the coupling device has a cable passing portion through which the power cable of the lighting device supplied with electricity through the power cable passes, and the cable passing portion is provided on a part different from the coupling part.
